(19) United States
(12) Patent Application Publication
(10) Pub. No.: US 2009/0161210 A1
(43) Pub. Date: Jun. 25, 2009

(54) MICROSCOPY SYSTEM WITH REVOLVABLE STAGE

(76) Inventors: Chien-Chung FU, Hsinchu City (TW); Hsiu-Ming Chang, Hsinchu City (TW); Ann-Shyn Chiang, Hsinchu City (TW)

Correspondence Address: Muncy, Geissler, Olds & Lowe, PLLC, P.O. BOX 1364, FAIRFAX, VA, 22038-1364, US

(21) Appl. No.: 12/336,306

(22) Filed: Dec. 16, 2008

(30) Foreign Application Priority Data
Dec. 20, 2007 (TW) 096149047

(51) Int. Cl. G02B 21/26

(52) U.S. Cl. 359/393

(57) ABSTRACT

A microscopy system includes an objective lens and a stage for holding a sample. The objective lens focuses incident light coming from one side of the objective lens to the sample disposed on the other side of the objective lens, and focuses an optical signal emitted from the sample to a photosensor disposed on the one side of the objective lens. The stage supports the sample and is configured to be revolvable about an axis, which is substantially perpendicular to an extending direction from the sample to the objective lens.

This application claims priority of No. 096149047 filed in Taiwan R.O.C. on Dec. 20, 2007 under 35 USC 119, the entire content of which is hereby incorporated by reference.

### BACKGROUND OF THE INVENTION

1. Field of Invention

The invention relates in general to a microscopy system, and more particularly to a microscopy system having a revolvable stage.

2. Related Art

Confocal laser scanning microscopy (CLSM or LSCM) is a valuable tool for obtaining high resolution images and 3-D reconstructions by using a spatial pinhole to eliminate out-of-focus light or flare. This technology permits one to obtain images of various Z-axis planes (Z-stacks) of the sample. The detected light originating from an illuminated volume element within the specimen represents one pixel in the resulting image. As the laser scans over the plane of interest, a whole image is obtained pixel by pixel and line by line. The beam is scanned across the sample in the horizontal plane using one or more (servo-controlled) oscillating mirrors. Information can be collected from different focal planes by raising or lowering the microscope stage. The computer can calculate and then generate a three-dimensional picture of the specimen by assembling a stack of these two-dimensional images from successive focal planes.

However, the Z-axis direction in the stacked 3D image has a much poor resolution (e.g., about 1.2 μm/slice) than in the X-axis and Y-axis directions (about 0.15 μm/pixel) under the limitation of the dimension of the pinhole and other mechanical or physical properties. A poor resolved Z-axis direction hampers the spatial reliability of the high resolution neural network images reconstructed, especially when comparison of two different samples is necessary. One of the inventors, Ann-Shyn Chiang, has disclosed an aqueous tissue clearing solution in U.S. Pat. No. 6,472,216 B1. In the '216 patent, the depth of observation may reach the level of micrometers. In the current developing method, fluorescent molecules are attached to or combined with the biological tissue. Thus, making the tissue become transparent is a key point for the break-through of the depth of observation, and the way of solving the bottleneck of the Z-axis resolution is greatly needed.

### SUMMARY OF TIRE INVENTION

It is therefore an object of the invention to provide a microscopy system with a revolvable stage for revolving a sample and holding the sample in a saturated condition so that the resolution of 3D image sensing can be increased.

The invention achieves the above-identified object by providing a microscopy system including an objective lens and a stage for holding a sample. The objective lens focuses incident light coming from one side of the objective lens to the sample disposed on the other side of the objective lens, and focuses an optical signal emitted from the sample to a photosensor disposed on the one side of the objective lens. The stage supports the sample and is configured to be revolvable about an axis, which is substantially perpendicular to an extending direction from the sample to the objective lens.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic illustration showing a microscopy system according to a first embodiment of the invention.

FIG. 2 shows a first state of the microscopy system of FIG. 1.

FIG. 3 shows a second state of the microscopy system of FIG. 1.

FIG. 4 is a schematic illustration showing a microscopy system according to a second embodiment of the invention.

FIG. 5 shows an example of a revolvable stage according to the invention.

FIG. 6 shows another example of the revolvable stage according to the invention.

FIG. 7 shows an example of a revolvable platen according to the invention.

FIG. 8 shows another example of the revolvable platen according to the invention.

### DETAILED DESCRIPTION OF THE INVENTION

The present invention will be apparent from the following detailed description, which proceeds with reference to the accompanying drawings, wherein the same references relate to the same elements.

The present inventors have found that the sample may be revolved by a specific angle about an X-axis or a Y-axis. Then, the image synthesis may be performed by way of image processing in order to solve the problem of the too-low resolution in the Z-axis direction. In order to achieve this effect, a stage for supporting and holding the sample has to be configured to be revolvable. It is to be noted that the term “revolvable” covers the rotatable ranges from 0 to 360 degrees, and this rotation may be out of the plane of the microscope platen. That is, the axis of rotation is not perpendicular to the plane of the microscope platen. The detailed structure of the microscopy system of the invention will be described in the following.

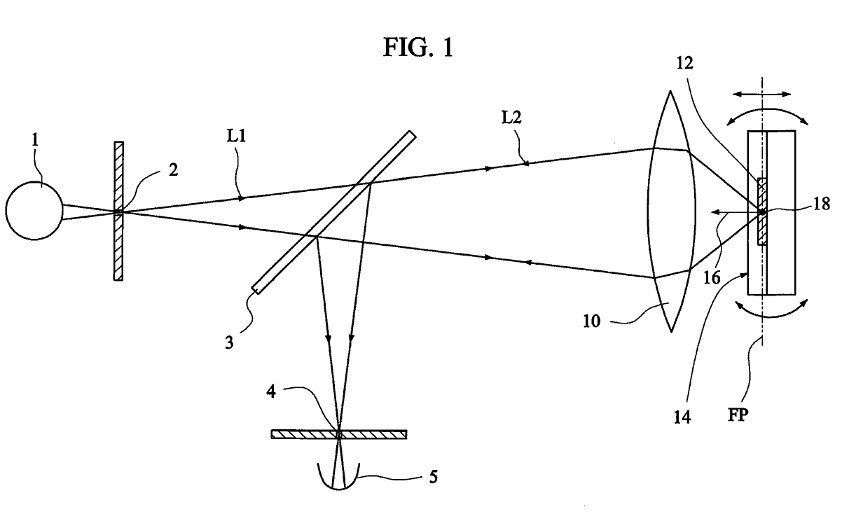

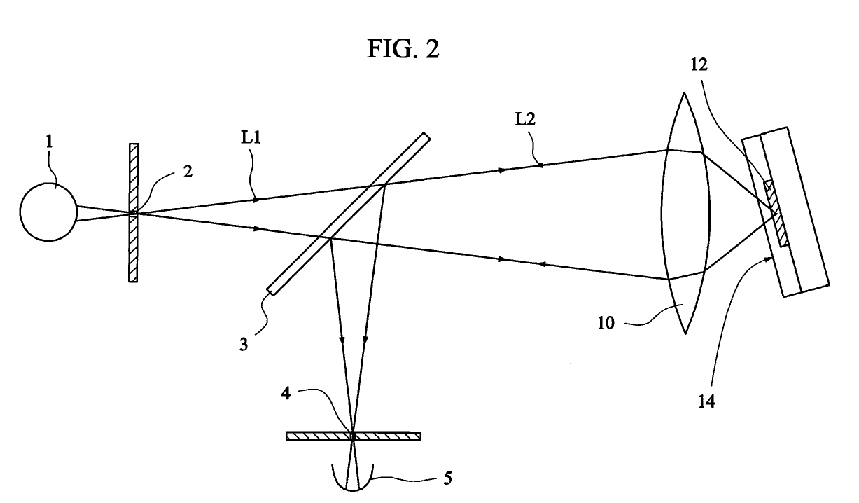

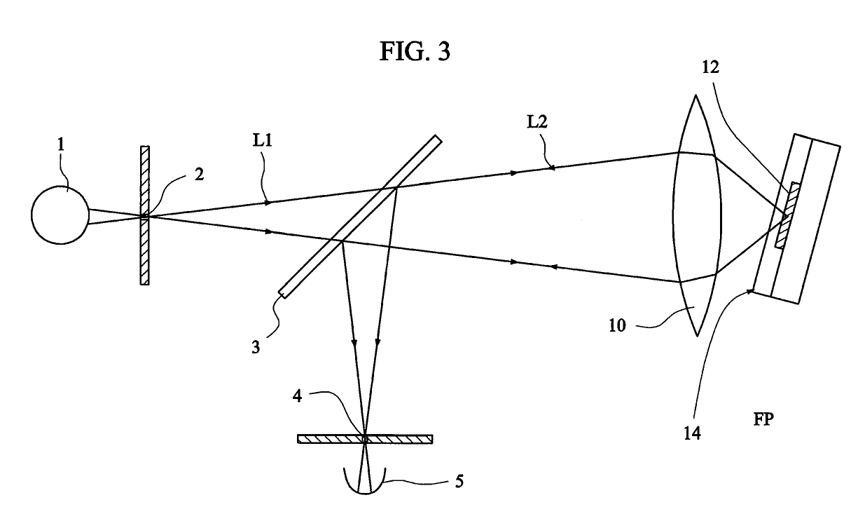

FIG. 1 is a schematic illustration showing a microscopy system according to a first embodiment of the invention. FIG. 2 shows a first state of the microscopy system of FIG. 1. FIG. 3 shows a second state of the microscopy system of FIG. 1. Referring to FIGS. 1 to 3, the microscopy system of this embodiment includes an objective lens 10 and a stage 14 for holding a sample 12.

The objective lens 10 focuses incident light L1, coming from one side of the objective lens 10, to the sample 12 disposed on the other side of the objective lens 10, and focuses an optical signal, emitted from the sample 12, to a photosensor 5 disposed on the one side of the objective lens 10. The stage 14 supports the sample 12 and is configured to be revolvable about an axis 18, which is substantially perpendicular to an extending direction 16 from the sample 12 to the objective lens 10, as shown in FIGS. 2 and 3. The sample 12 may be, for example, a brain of an insect.

When being applied to the CLSM, the microscopy system may further include a light source 1, a light input aperture 2, a beam splitter 3, a light output aperture 4 and the photosensor 5. For example, the light source 1, such as a laser light source, outputs the incident light L1 to the sample 12 sequentially through the light input aperture 2, the beam splitter 3 and the objective lens 10 so that reflected light L2 is generated. The reflected light L2 passes through the objective lens 10 and is reflected, by the beam splitter 3, to the photosensor 5 through the light output aperture 4.

In one example, the stage 14 may also be configured to be movable along the extending direction 16. Therefore, the photosensor 5 may sense the sample 12 disposed on a focus plane FP so that the stage 14 can be moved along the extending direction 16, the sample 12 can be moved along the extending direction 16, and various images at various depths of the sample 12 may be located on the focus plane FP.

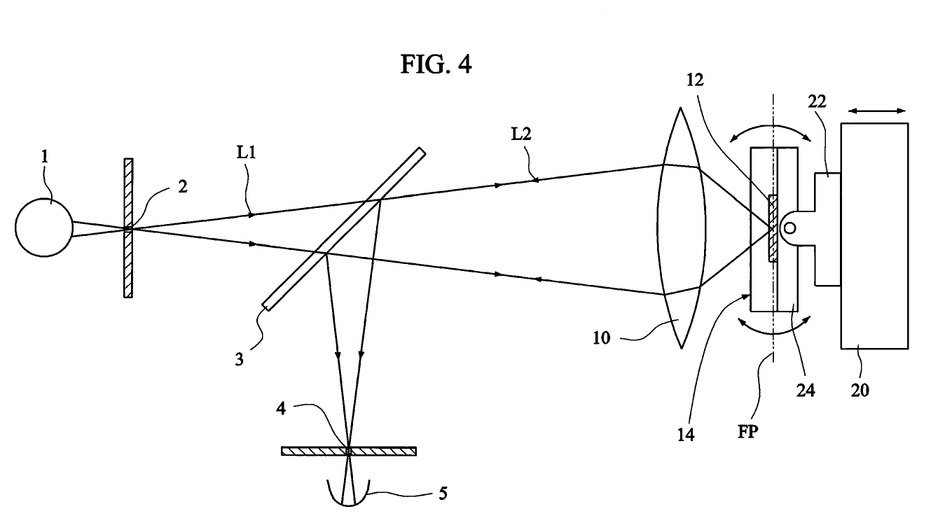

FIG. 4 is a schematic illustration showing a microscopy system according to a second embodiment of the invention. Referring to FIG. 4, the microscopy system of this embodiment further includes a movable stage 20 for supporting the stage 14. The movable stage 20 is configured to be movable along the extending direction 16. Consequently, the stage 14 needs not to have to be movable.

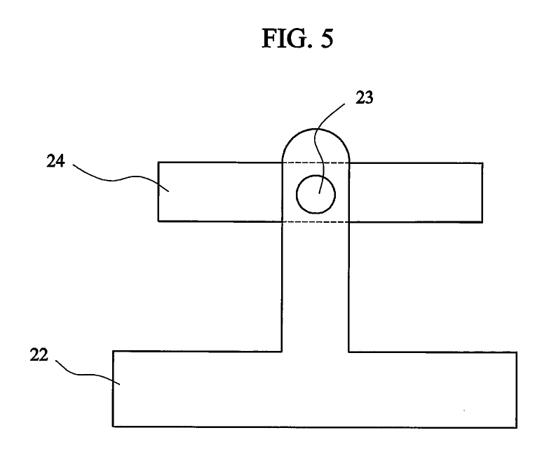

FIG. 5 shows an example of a revolvable stage according to the invention. In the first and second embodiments, the stage 14 may include a base 22 and a revolvable platen 24. The revolvable platen 24 for supporting the sample 12 is rotatably mounted on the base 22 through a pivot 23. For example, the revolvable platen 24 is a flat plate.

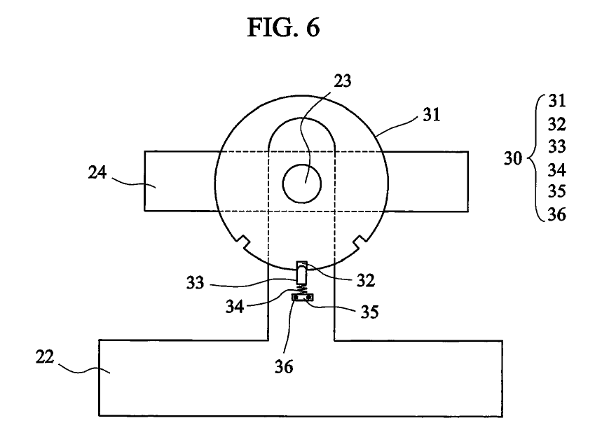

FIG. 6 shows another example of the revolvable stage according to the invention. Referring to FIG. 6, the stage 14 further includes a positioning mechanism 30 for positioning a revolving angle of the revolvable platen 24 in a stepwise manner. In this example, the positioning mechanism 30 includes a wheel 31 and a pin 33. The wheel 31 is formed with a plurality of recesses 32. A supporting block 35 is fixed to the base 22 through a screw 36. A spring 34 is fixed to the supporting block 35 to push the pin 33. The pin 33 may be inserted into the recesses 32 so as to fix the wheel 31 at various revolving angles, respectively. The user can pull down the pin 33 to make the wheel 31 be revolvable. The wheel 31 and the revolvable platen 24 synchronously revolve through the pivot 23. The positioning mechanism 30 may position the revolvable platen 24 at two symmetrical revolving angles with respect to the extending direction 16. In another embodiment, the revolvable platen 24 may be revolved through a worm wheel and a worm shaft, or may be rotated by a motor.

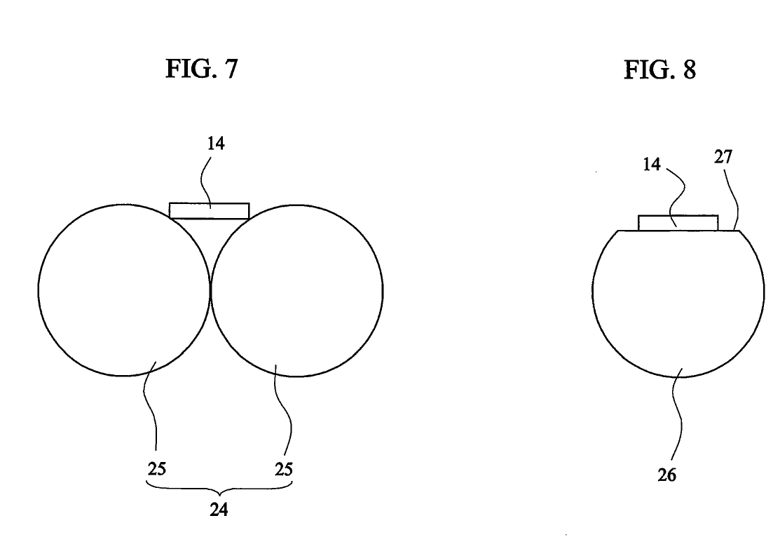

FIG. 7 shows an example of a revolvable platen according to the invention. Because the magnification power of the objective lens in the high-magnification microscope is relatively high, the sample 12 has to be very close to the objective lens 10. The size of the stage 14, which is close to the objective lens 10, cannot be too large, or the revolving stage 14 may touch the objective lens 10 or even cannot be revolved. Thus, the invention is implemented as the architecture shown in FIG. 7, wherein the revolvable platen 24 is composed of two optical fibers 25, and the stage 14 is placed on the two optical fibers 25.

FIG. 8 shows another example of the revolvable platen according to the invention. As shown in FIG. 8, the revolvable platen 24 is composed of a cylinder 26, which is formed with a plane 27 to be in contact with the stage 14. The cylinder 26 may also be an optical fiber, for example.

The microscopy system with the revolvable stage according to the invention makes the sample be revolvable. In addition, many layers, which are stacked in the Z-axis direction and are gathered at different revolving angles, such as 0 and 90 degrees, can be integrated. So, it is possible to reconstruct a three-dimensional image having the high resolution at three primary axes, and thus to implement other diversified image sensing functions.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A microscopy system, comprising:
an objective lens for focusing incident light, coming from one side of the objective lens, to a sample disposed on the other side of the objective lens, and for focusing an optical signal, emitted from the sample, to one photosensor disposed on the one side of the objective lens; and
a stage for supporting the sample, the stage being configured to be revolvable about an axis, which is substantially perpendicular to an extending direction from the sample to the objective lens.

2. The microscopy system according to claim 1, wherein the stage is also configured to be movable along the extending direction.

3. The microscopy system according to claim 1, further comprising:
a movable stage for supporting the stage, the movable stage being configured to be movable along the extending direction.

4. The microscopy system according to claim 1, wherein the stage comprises:
a base; and
a revolvable platen, which is rotatably mounted on the base and is for supporting the sample.

5. The microscopy system according to claim 4, wherein the revolvable platen is a flat plate.

6. The microscopy system according to claim 4, wherein the revolvable platen is composed of two optical fibers.

7. The microscopy system according to claim 4, wherein the revolvable platen is composed of a cylinder having a plane contacting with the stage.

8. The microscopy system according to claim 4, wherein the stage further comprises:
a positioning mechanism for positioning a revolving angle of the revolvable platen in a stepwise manner.

9. The microscopy system according to claim 8, wherein the positioning mechanism can position the revolvable platen at two symmetrical revolving angles with respect to the extending direction.

10. The microscopy system according to claim 4, wherein the revolvable platen is driven to revolve by a worm wheel and a worm shaft.

11. The microscopy system according to claim 4, wherein the revolvable platen is driven to revolve by a motor.

12. The microscopy system according to claim 1, further comprising a light source, a light input aperture, a beam splitter and a light output aperture, wherein the light source outputs the incident light to the sample sequentially through the light input aperture, the beam splitter and the objective lens, the sample generates reflected light, and the reflected light passes through the objective lens and is reflected, by the beam splitter, to the photosensor through the light output aperture.
